(19) United States
(12) Patent Application Publication
(10) Pub. No.: US 2014/0057069 A1
(43) Pub. Date: Feb. 27, 2014

(54) Interfolded Uneven Z-fold Absorbent Sheet Materials

(71) Applicants: Cancan Huang, Allen, TX (US); Weihu Ying, Guangzhou (CN); Yongyuan Lin, Guangzhou (CN)

(72) Inventors: Cancan Huang, Allen, TX (US); Weihu Ying, Guangzhou (CN); Yongyuan Lin, Guangzhou (CN)

(73) Assignees: Weihu Ying, Guangzhou (CN); Cancan Huang, Allen, TX (US)

(21) Appl. No.: 13/610,868

(22) Filed: Sep. 12, 2012

(30) Foreign Application Priority Data
Aug. 23, 2012 (CN) 201220422125

(51) Int. Cl. B32B 3/04

(52) U.S. Cl. 428/126

(57) ABSTRACT

A product comprising a stack of interfolded absorbent sheet materials. Each sheet is folded about a first and a second traverse fold axis into three consecutive segments. The middle segment of each sheet has the same dimension. Each sheet has the end segments positioned on the opposite sides of the middle segments forming a Z-shape cross-sectionally. Each sheet has the sum of the lengths of the end segments less than or substantially equal to the length of the middle segment. The middle segment of each sheet overlaps with the first end segment of its immediate succeeding sheet. The second end segment of each sheet overlaps with the middle segment of its immediate succeeding sheet. The second traverse fold axis of each sheet completely overlaps with the first traverse fold axis of the immediate succeeding sheet.

The present application claims priority to Chinese Patent Application No. 201220422125, filed Aug. 23, 2012.

### FIELD OF DISCLOSURE

This disclosure relates to dispensing absorbent sheet materials, and more particularly, to folding configurations and interfolding arrangements for a stack of absorbent sheet materials.

### BACKGROUND

In commercial food establishments and restrooms or even home settings, disposable napkins or towels have commonly replaced traditional cloth ones for their convenience, sanitary and cost-efficiency advantages. Disposable napkins or towels are often supplied in stacks and dispensed through a commercially available dispenser, which allows end users to self-help.

Interfolded dispensing napkins or towels provide the convenience that when one user pulls a sheet out of a dispenser, the immediate next sheet is also subject to a pulling force making it partially protrude out of the dispensing opening for next user to readily access.

In commercial settings, disposable napkins or towels are usually provided by service providers, such as restaurant owners, to the end users for free. However, a significant number of users tend to consume more napkins than needed causing considerable economical and environmental waste. Interfolded napkins or towels offer the advantage that a user can normally draw only one sheet from the dispenser at a time.

Encouraging an end user to make efficient use of each napkin or towel that has been removed from the dispenser before discarding is another approach to further cut down the consumption of the napkins or towels and the eventual environmental waste. The interfolded napkins or towels prevalent in current market are folded into quarters from an original rectangular sheet by evenly bisecting about two axes that are perpendicular to each other, as shown in FIG. 1.

All the free edges of the panels are superposed on each other. An original unfolded sheet with dimension of 8.5 inches×13 inches is thus folded into 4.25 inches×6.5 inches approximately. Although the usable surface area of such a napkin is much larger than the outer surface area due to the folding configuration, it is discovered that a significant number of users never unfold the napkins to take the advantage of the inner surface areas, which defeats the purposes of providing a high quality and generous size napkin material.

### SUMMARY OF INVENTION

Disclosed herein are folding configurations and interfolding arrangements of s stack of absorbent sheet materials.

In a stack of absorbent sheet materials, each sheet of the absorbent sheet materials is folded about a first traverse fold axis and a second traverse fold axis into a first end segment, a middle segment and a second end segment. The middle segment of each sheet in the stack has the same dimension. Each sheet has the first end segment adjoining the middle end segment along the first traverse fold axis, and the middle segment adjoining the second end segment along the second first traverse fold axis. The end segments are positioned on the opposite sides of the middle segments, which forms a Z-shape cross-sectionally. In each sheet, the sum of the end segments lengths is less than or substantially equal to the length of the middle segment. The middle segment of each sheet overlaps with the first end segment of its immediate succeeding sheet. The second end segment of each sheet overlaps with the middle segment of the immediate succeeding sheet. The second traverse fold axis of each sheet completely overlaps with the first traverse fold axis of the immediate succeeding sheet.

In some embodiments, each sheet is folded about at least one longitudinal fold axis.

In some embodiments, each sheet in the stack is originally 13 inch by 8.5 inch before folding. The length ratio among the first end segment, the middle segment, and the second end segment of each folded sheet may be 1:6:5.

In some embodiments, each of said absorbent sheet materials is a single ply paper napkin having a basis weight of from 11 to 17 lb approximately.

In some embodiments, the first end segment of each sheet in the stack has the same dimension with the first end segment of the immediate succeeding sheet. In some other embodiments, the first end segment of each sheet in the stack has the same length with the second end segment of immediate succeeding sheet. In still other embodiments, the first segment of each sheet has the same length as the first segment of immediate succeeding sheet.

In some embodiments, the middle segment and second end segments of each sheet sandwiches the first end segment and the middle segment of the immediate succeeding sheet. In some other embodiments, the middle segment and second end segments of each sheet are sandwiched between the first end segment and the middle segment of the immediate succeeding sheet.

In some embodiments, each sheet in the stack is entirely detached from all other absorbent sheets within said stack.

### BRIEF DESCRIPTION OF THE DRAWINGS

Reference will be made to embodiments of the disclosure, examples of which may be illustrated in the accompanying figures. These figures are intended to be illustrative, not limiting. Any alterations and further modifications of the inventive features illustrated herein, and any additional applications of the principles of the disclosure as illustrated herein, which would normally occur to one having ordinary skills in the art, are to be considered within the scope of the disclosure.

FIG. 1 is a schematic perspective view of a quarterly folded napkin that can be assembled into an interfold stack in accordance with prior art.

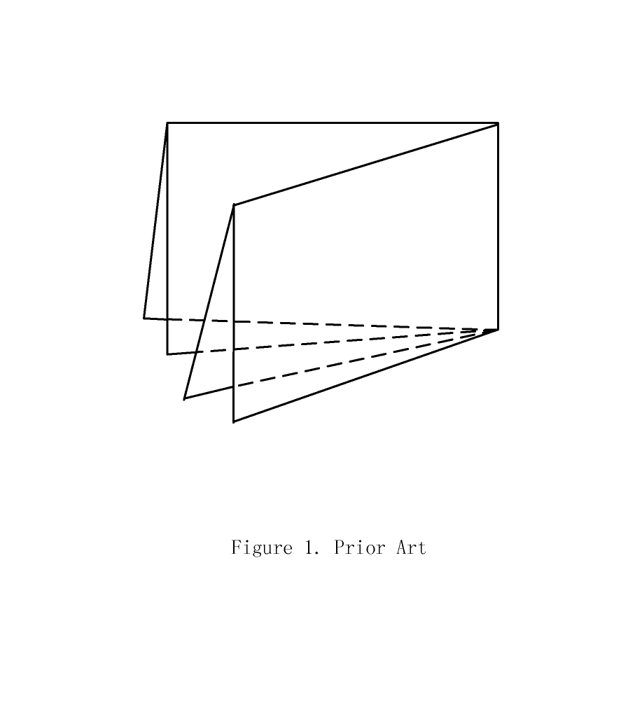

FIG. 2 is a layout of an unfolded napkin illustrating the locations of the longitudinal and traverse fold axes in accordance with the present disclosure.

FIG. 3A is a schematic perspective view illustrating the folding mechanism for a napkin in accordance with the present disclosure where the napkin is folded about one longitudinal axis and two traverse axes.

FIG. 3B is a schematic perspective view illustrating the folding mechanism for a napkin in accordance with the present disclosure where the napkin is folded about two longitudinal axes and two traverse axes.

FIG. 4A is a schematic cross-section view of one embodiment of an interfolding arrangement in accordance with the present disclosure illustrating the orientation of each Z-shape napkin relative to the dispenser and the interfolding relationship among adjacent napkins.

FIG. 4B is a schematic cross-section view of a second embodiment of an interfolding arrangement in accordance with the present disclosure illustrating the orientation of each Z-shape napkin relative to the dispenser and the interfolding relationship among adjacent napkins.

FIG. 4C is a schematic cross-section view of a third embodiment of an interfolding arrangement in accordance with the present disclosure illustrating the orientation of each Z-shape napkin relative to the dispenser and the interfolding relationship among adjacent napkins.

FIG. 4D is a schematic cross-section view of a fourth embodiment of an interfolding arrangement in accordance with the present disclosure illustrating the orientation of each Z-shape napkin relative to the dispenser and the interfolding relationship among adjacent napkins.

FIG. 5 is a collapsed cross-section view of the embodiment of stack of interfolded napkins corresponding to FIG. 4A and illustrating a uniform density pack of napkins.

### DETAILED DESCRIPTION OF THE INVENTION

Although references are made throughout this disclosure to napkins or paper napkins as an exemplary embodiment for the sake of convenience, the term “absorbent sheet materials” refers to any web product, including but not limited to table napkins, tissues, towels, hankies, wet wipes, and the like. The products are useful for household chores, cleaning, personal care, healthcare, food wrapping, and cosmetic application or removal. The absorbent sheet materials can be made of any suitable substrate material, including but not limited to paper, woven materials, non-woven materials, hydro-entangled materials, air-entangled materials, and the like. The substrate material can be made from wood or non-wood fibers, and the like.

An unfolded napkin, having a single ply or multiple plies, can be in a rectangular or square shape. Typically, the dimension can be varied in a large range depending on the particular requirements from applications and manufacturing. approximately 8˜10 inches wide and 11˜14 inches long. For example, in some embodiments, an unfolded napkin has the original size of 8.5 inches×13 inches.

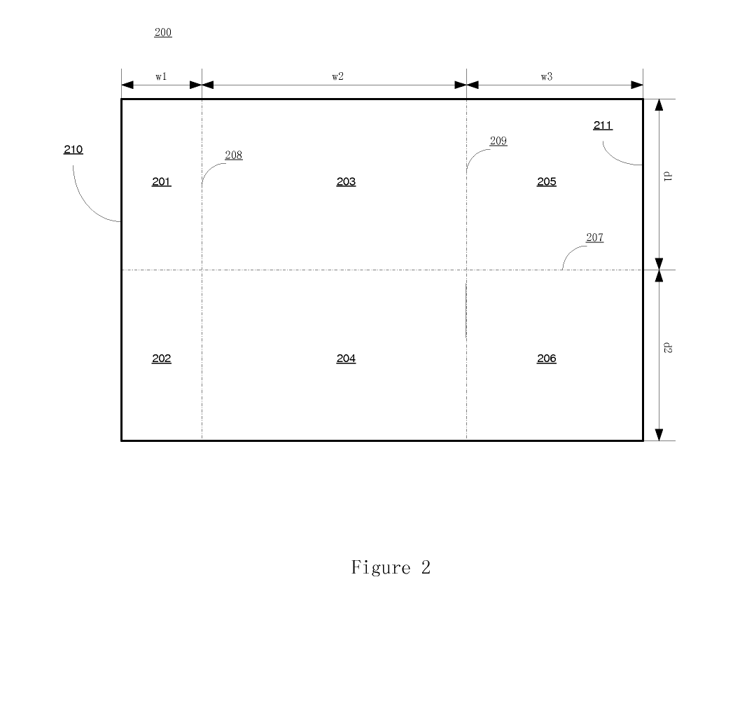

FIG. 2 depicts the layout of an unfolded rectangular napkin that is divided into 6 uneven panels 201-206 by three fold axes 207-209 of which locations are determined in accordance with one embodiment of this disclosure. In manufacture, the longitudinal edges may be oriented in the “machine direction.” The longitudinal fold axis 207 is parallel to the longitudinal edges of the napkin 200. The napkin is divided into an upper region and a lower region with width being d1 and d2 respectively. In some embodiments, the two regions are of substantially equal size (d1=d2), which serves to render uniform packing density in an interfolded stack and consequently facilitates large volume transportation or storage of the napkins. However, in some other embodiments, d1 can be made different from d2 to fit in dispensers of particular dimensions. Each of the upper and lower regions are further divided into three panels by the traverse fold axes 208 and 209 that are perpendicular to the longitudinal fold axis 207. w1, w2 and w3 label the lengths of the panels. The sum of w1 and w3 is less than or substantially equal to w2.

In the embodiments featuring the sum of w1 and w3 being considerably less than w2, the present disclosure requires an unfolded napkin with a smaller dimension than the quarterly folded napkins to attain the same folded size. Thus, the cost of production is reduced.

In some other embodiments, as the napkins illustrated in FIG. 2, the sum of w1 and w3 is substantially equal to w2. The ratio w1:w2:w3 can be varied to meet particular requirements of applications and manufacturing of the napkins. In some embodiments, the ratio w1:w2:w3 can be substantially equal to 1:6:5. Thus, for a napkin with unfolded dimension of 8.5 inches×13 inches, w1, w2 and w3 are approximately 1.1, 6.6 and 5.5 inches respectively. In some other embodiments, w1, w2 and w3 are about 4.9, 6.5 and 1.6 inches respectively. In still some other embodiments, the ratio can be 1:2:1, resulting w1, w2 and w3 being about 3.25, 6.5 and 3.25 inches respectively.

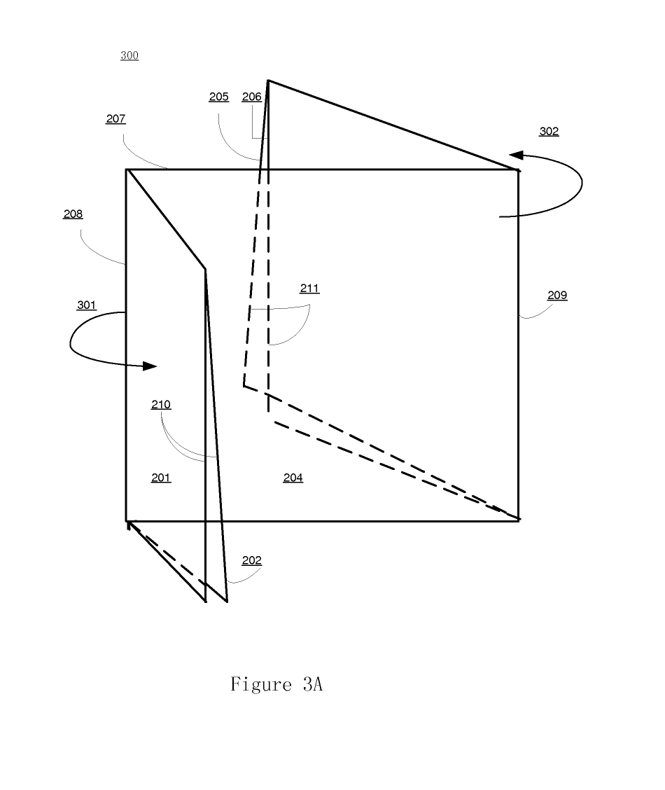

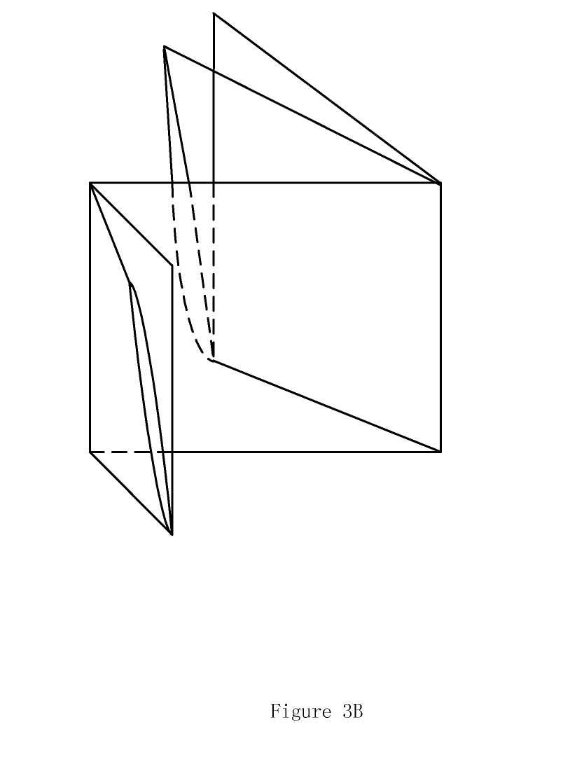

Referring to FIG. 3A, the each napkin to be assembled into a stack is folded about the longitudinal fold axis 207 and the traverse fold axes 208 and 209. The traverse folds follow the directions indicated by arrows 301 and 302 in FIG. 3A. By this means, each napkin is folded into a “Z” shape with the left end panel pair 201 and 202 and the right end panel pair 205 and 206 being disposed in the opposite sides of the middle pair 203 and 204. Because both w1 and w3 are smaller than w2, the free edges of the end panels 201, 202, 205 and 206 are positioned away from the traverse fold axes at least in distances that are perceivable by the end users. The middle panel 203 is invisible in FIG. 3A for being completely hidden by panel 204.

As will be appreciated by a person having ordinary skill in the art, the original sheet can also be folded about two or even more longitudinal fold axes, as illustrated in FIG. 3B. Multiple longitudinal folds may be needed to fit the napkins into a relatively small size dispenser while maintain the same useable surface areas. However, in some other embodiments, the napkin is not folded along any longitudinal fold axis.

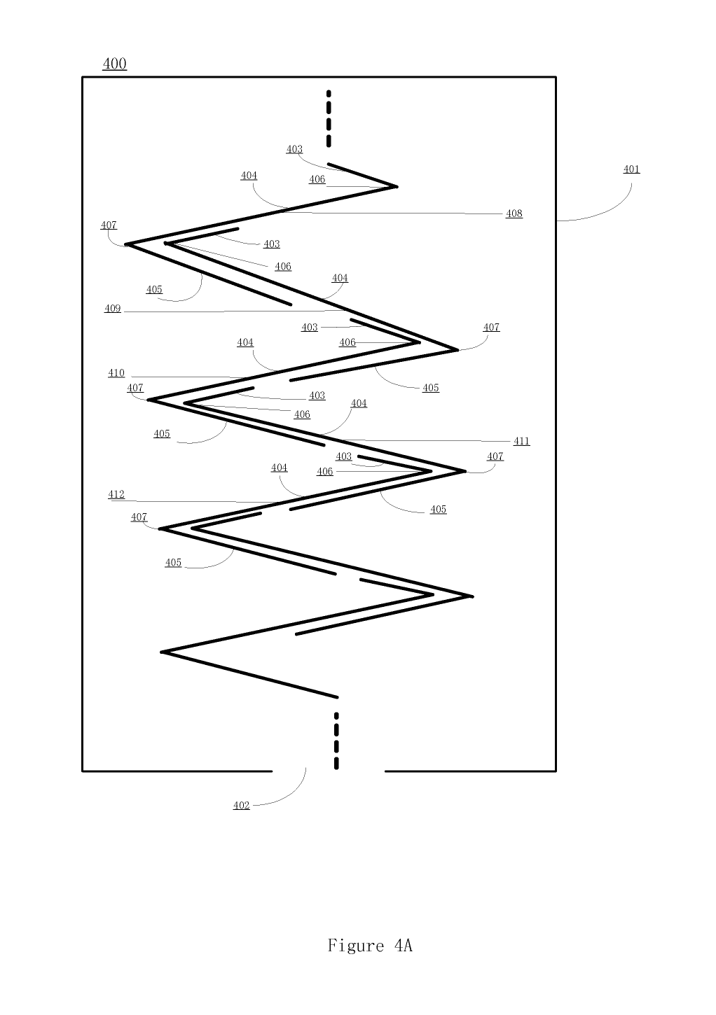

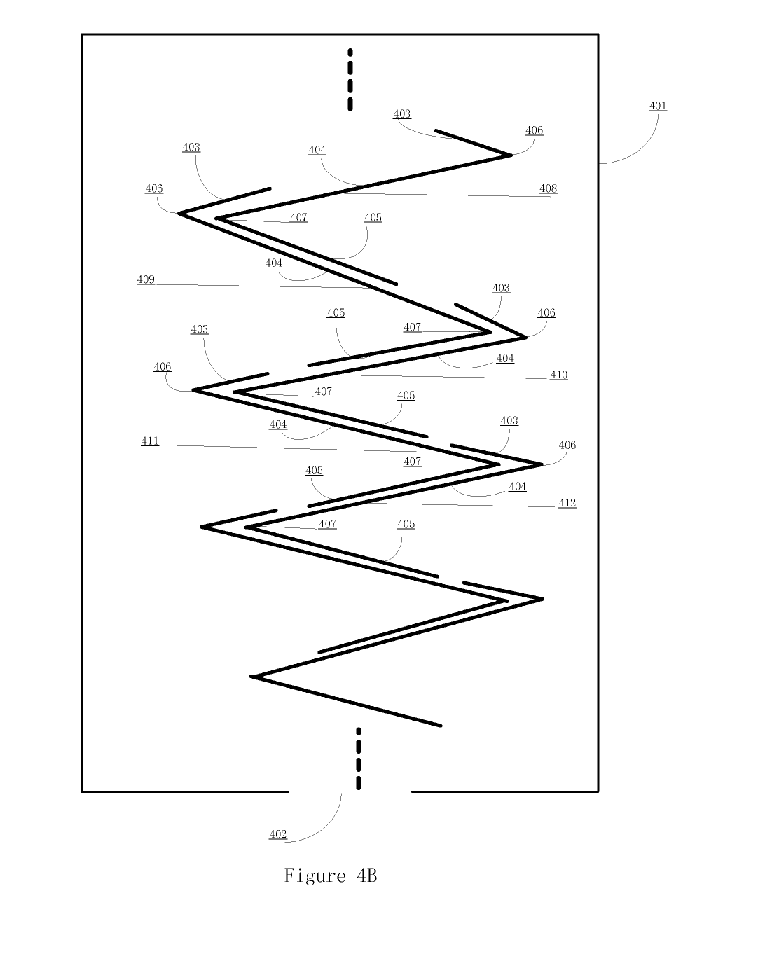

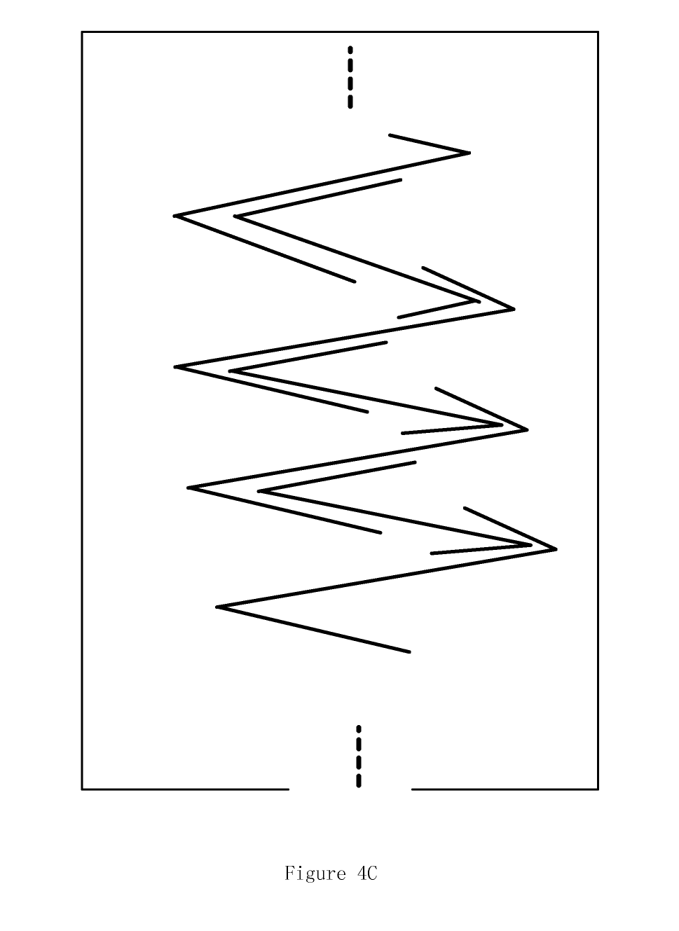

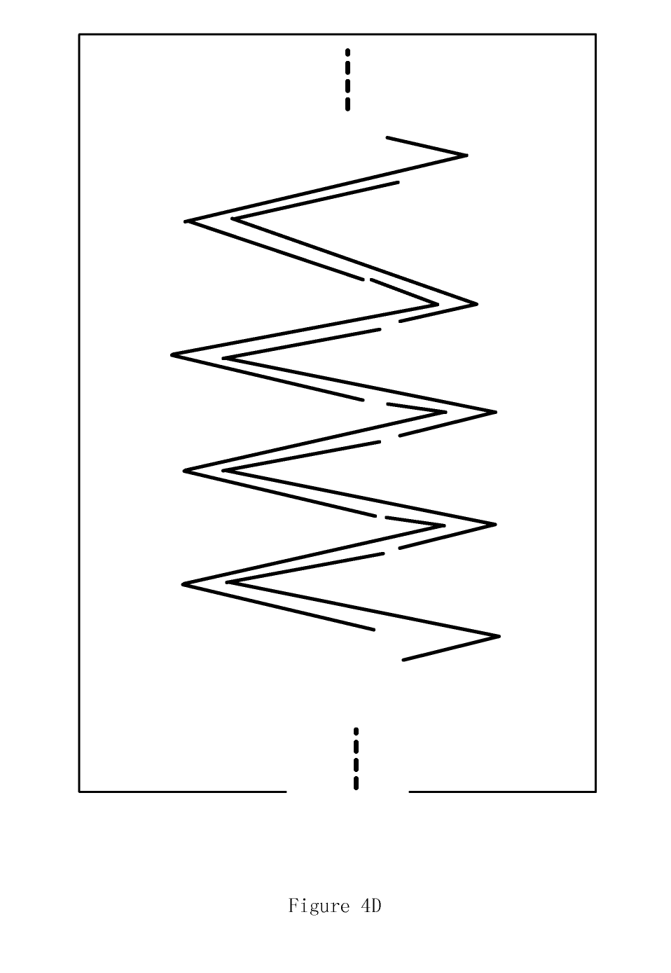

A number of unevenly folded Z-shape napkins are subsequently assembled into a stack with each napkin interfolding with the adjacent ones. FIG. 4A illustrates a cross-sectional view of a portion of an interfolding stack placed in a napkin dispenser 401 having an access opening 402 at the bottom. Each folded napkin is represented by a simplified “Z” model in FIG. 4A-D featuring a first end segment 403 that faces the top of the dispenser, a middle segment 404 and a second end segment 405 that faces the bottom of the dispenser. Specifically in FIGS. 4A and 4B, the first end segment corresponds to the left end panel pair 201 and 202 in FIG. 3A having the length of w1, the middle segment 404 corresponds to the middle pair 203 and 204 in FIG. 3A having the length of w2, and the second end segment 405 corresponds to the right end panel pair 205 and 206 in FIG. 3A having the length of w3. In the cross-sectional view, each napkin in FIGS. 4A and 4B is in a horizontally flipped orientation compared to its preceding napkin.

Counted from the top of the portion of the stack that is shown in FIG. 4A, the first end segment 403 and middle segment 404 of the second napkin 409 are placed in between the middle segment 404 and the second end segment 405 of the first napkin 408 with the second traverse fold axis 407 of first napkin 408 completely overlaps the first traverse fold axis 406 of the second napkin 409. In other words, the lower two segments 404 and 405 of the first napkin 408 sandwiches the upper two segments 403 and 404 of the second napkin 409. Similarly, the first end segment 403 and the middle segment 404 of the third napkin 410 are placed in between the middle segment 404 and the second end segment 405 of the second napkin 409 with the second traverse fold axis 407 of the second napkin 409 completely overlaps the first traverse fold axis 406 of the third napkin 410. As a consequence, the middle segment 404 of the second napkin 409 covers both the second end segment 405 of the first napkin 408 and the first end segment of the third napkin 410. The third napkin 410 interfolds with the fourth napkin 411 by repeating the same manner as the first napkin 408 interfolds with the second napkin 409. The fourth napkin 411 interfolds with the fifth 412 by repeating the same manner as the second napkin 409 interfolds with the third napkin 411, etc. The same interfolding pattern is repeated to develop a stack composed of any desired number of napkins. In some embodiments, the stack may consist of 600 to 900 sheets. In some embodiments, w2 is substantially equal to w1+w3, which offer the advantage of uniform density stack of napkins.

In some other embodiments, the interfolding arrangement shown in FIG. 4B can be applied to the napkins folded in accordance with FIGS. 2 and 3. Similar with the arrangement in FIG. 4A, all the napkins have the first end segments the same length w1. The difference is that the middle segment 404 and the second end segment 405 of the first napkin 408 are placed in between the first end segment 403 and middle segment 404 of the second napkin 409 with the second traverse fold axis 407 of the first napkin 408 completely overlaps the first traverse fold axis 406 of the second napkin 409. In other words, the lower two segments 404 and 405 of the first napkin 408 are sandwiched by the upper two segments 403 and 404 of the second napkin 409. The middle segment 404 and the second end segment 405 of the second napkin 409 are placed in between the first end segment 403 and the middle segment 404 of the third napkin 410 with the second traverse fold axis 407 of the second napkin 409 completely overlaps the first traverse fold axis 406 of the third napkin 410. The same pattern is repeated on the succeeding napkins.

In still some other embodiments, as the stacks shown in FIGS. 4C and 4D, a napkin having the first end segment (facing the top of the dispenser) equal to w1 alternates with another napkin having the first end segment (facing the top of the dispenser) equal to w3. In the cross-sectional view, each napkin is in a vertically flipped orientation comparing to the preceding one. Otherwise, the arrangements shown in FIGS. 4C and 4D are the same as the arrangements show in FIGS. 4A and 4B respectively.

As appreciated by a person having ordinary skills in the art, the stacks of napkins made by the folding configuration and interfolding arrangement in accordance with this disclosure can be used in combination with a dispenser that has an opening at the top or at the bottom, and the opening may be positioned either at the center or off-axis.

The foregoing folding configuration and interfolding arrangement offer the advantage of dispensing a single napkin at one time by an end user at the opening of a dispenser. In some embodiments, the bottom-most napkin in a dispenser may protrude out of the opening.

Moreover, since the smaller end panels conspicuously sit over both sides of a folded napkin, the end users can easily grab the free edges of the smaller panels and thus are encouraged to unfold along the traverse fold axes to use the hidden inner surfaces for wiping. As a consequence, a smaller number of napkins are consumed by the users and so the cost to provide napkins to end users is reduced.

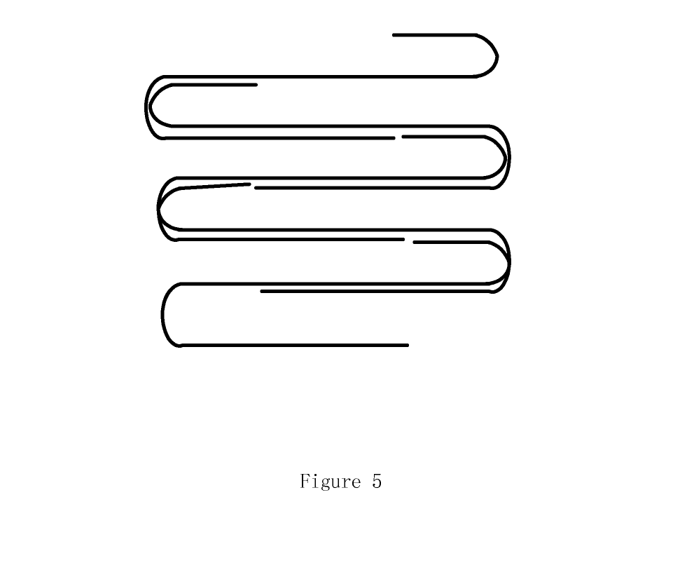

FIG. 5 depicts a collapsed view of the interfolded napkin stack shown in FIG. 4A, each napkin having all panel surfaces parallel to each other. The stack has uniform height across each napkin surface.

Specific embodiments of the invention have been shown in the drawings and described in detail herein to help elucidate the inventive concepts. It should be understood, however, that the invention is not to be limited to the particular forms disclosed; rather, the invention is to cover all modifications, equivalents, and alternatives falling within the scope of the following claims.

We claim:

1. A product comprising
a stack of absorbent sheet materials, each of the absorbent sheet materials being folded about a first traverse fold axis and a second traverse fold axis into a first end segment, a middle segment and a second end segment,
wherein the middle segment of said each absorbent sheet materials in the stack has the same dimension,
wherein said each of the absorbent sheet materials has the first end segment adjoining the middle end segment along the first traverse fold axis, and the middle segment adjoining the second end segment along the second first traverse fold axis,
wherein said each of the absorbent sheet materials has the end segments positioned on the opposite sides of the middle segments forming a Z-shape cross-sectionally,
wherein, said each of the absorbent sheet materials has the sum of the lengths of the end segments less than or substantially equal to the length of the middle segment, and
wherein, the middle segment of said each absorbent sheet material overlaps with the first end segment of its immediate succeeding absorbent sheet material, the second end segment of said each absorbent sheet material overlaps with the middle segment of its immediate succeeding absorbent sheet material, and wherein the second traverse fold axis of said each absorbent sheet material completely overlaps with the first traverse fold axis of the immediate succeeding absorbent sheet material.

2. The product of claim 1, wherein each of the absorbent sheet material is folded about at least one longitudinal fold axis.

3. The product of claim 2, wherein each of the absorbent sheet material is folded to trisect along two longitudinal fold axes.

4. The product of claim 1, where in the absorbent sheet materials are made from wood-fibers.

5. The product of claim 1, wherein said each of the absorbent sheet material is single ply before any folding operation.

6. The product of claim 1, wherein said each of the absorbent sheet materials is in rectangular shape with a dimension of 13 inch by 8.5 inch before folding

7. The product of claim 1, wherein the length ratio among the first end segment, the middle segment, and the second end segment of said each of the absorbent sheet materials is 1:6:5.

8. The product of claim 1, wherein each of said absorbent sheet materials is a single ply paper napkin having a basis weight of from 11 to 17 lb approximately.

9. The product of claim 1, wherein the first end segment of said each of the absorbent sheet materials has the same dimension with the first end segment of said immediate succeeding absorbent sheet material.

10. The product of claim 1, wherein the first end segment of said each of the absorbent sheet materials has the same length with the second end segment of said immediate succeeding absorbent sheet material.

11. The product of claim 1, wherein the first segment of said each of the absorbent sheet material has the same length as the first segment of said immediate succeeding absorbent sheet material.

12. The product of claim 1, wherein the middle segment and second end segments of said each of the absorbent sheet materials sandwiches the first end segment and the middle segment of the immediate succeeding absorbent sheet material.

13. The product of claim 1, wherein the middle segment and second end segments of said each of the absorbent sheet materials are sandwiched between the first end segment and the middle segment of the immediate succeeding absorbent sheet material.

14. The product of claim 1, wherein each of said absorbent sheet material is entirely detached from all other absorbent sheets within said stack.

15. The products of claim 1, wherein each of said absorbent sheet materials bears an embossed surface relief.

16. The products of claim 1, wherein each of said absorbent sheet materials is a napkin.
